(19) United States
(12) Patent Application Publication
(10) Pub. No.: US 2024/0088981 A1
(43) Pub. Date: Mar. 14, 2024

(54) WIRELESS COMMUNICATION SYSTEM, TERMINAL, AND CONTROL METHOD

(71) Applicant: NEC Corporation, Minato-ku, Tokyo (JP)

(72) Inventor: Kenji Wakafuji, (US)

(73) Assignee: NEC Corporation, Minato-ku, Tokyo (JP)

(21) Appl. No.: 18/269,457

(22) PCT Filed: Jan. 14, 2022
(86) PCT No.: PCT/JP2022/001029

§ 371 Date: Jun. 23, 2023

(30) Foreign Application Priority Data
Mar. 25, 2021 (JP) 2021-051506

(51) Int. Cl. H04B 7/06; H04B 7/08

(52) U.S. Cl. CPC H04B 7/06952; H04B 7/086

(57) ABSTRACT

A ground base station (10) and a high-altitude base station (20) perform transmission beam sweeping in an orientation of a terminal (30). The terminal (30) performs reception beam sweeping in an orientation of the ground base station (10) only for a time determined in advance and, when the terminal (30) is able to find the ground base station (10), the terminal (30) connects to the ground base station (10). When the terminal (30) is unable to find the ground base station (10), the terminal (30) starts reception beam sweeping in an orientation of the high-altitude base station (20) and, when the terminal (30) is able to find the high-altitude base station (20), the terminal (30) connects to the high-altitude base station (20).

### TECHNICAL FIELD

The present disclosure relates to a wireless communication system, a terminal, and a control method.

### BACKGROUND ART

Recently, in order to further improve communication speed, wireless communication utilizing high frequencies in the millimeter wave band is being realized in 5G (Generation) or the like. However, generally, wireless communication utilizing high frequencies suffers from large propagation loss. Therefore, with wireless communication utilizing high frequencies in the millimeter wave band such as 5G, a service area per base station is smaller than wireless communication utilizing frequencies of 6 GHz or lower such as 4G. In urban areas, since the number of accommodated terminals per base station is large, installing a base station with a small service area is commensurate with the cost thereof. On the other hand, in sparsely populated areas, since the number of accommodated terminals per base station is small, installing a base station with a small service area is not commensurate with the cost thereof. Therefore, in sparsely populated areas, a delay in development of 5G base stations is expected.

On the other hand, there have been reductions in satellite-launching cost and increases in the feasibility of HAPS (High Altitude Platform Station) which moves through the stratosphere. Therefore, it is conceivable that coverage of a wide range will become possible in the future through high-altitude base stations arranged in the stratosphere by methods such as mounting the base stations on a HAPS or the like (refer to Patent Literature 1). However, with a high-altitude base station, since a distance to terminals is greater as compared to a ground base station which is arranged on the ground, communication speeds as high as those of ground base stations cannot be produced.

### CITATION LIST

Patent Literature
Patent Literature 1: Japanese Unexamined Patent Application Publication No. 2021-013053

### SUMMARY OF INVENTION

### Technical Problem

As described above, recently, there has been an increase in the feasibility of high-altitude base stations arranged within a high altitude range such as the stratosphere. Therefore, two methods of connecting a terminal to a wireless network are conceivable in the future, namely, a conventional method of connecting to a ground base station and a method of connecting to a high-altitude base station.

However, with a ground base station, although there is an advantage of a high communication speed, there is also a disadvantage of a small service area. On the other hand, with a high-altitude base station, although there is an advantage of a large service area, there is also a disadvantage of a low communication speed.

Therefore, in the future, it is expected that there will be an increase in the significance of connecting terminals to a ground base station or a high-altitude base station in a short period of time while suppressing power consumption and minimizing communication speed loss by combining the advantage of a ground base station and the advantage of a high-altitude base station.

In consideration thereof, an object of the present disclosure is to solve the problem described above and to provide a wireless communication system, a terminal, and a control method which enable a terminal to be connected to a ground base station or a high-altitude base station in a short period of time while suppressing power consumption and minimizing communication speed loss.

### Solution to Problem

A wireless communication system according to an aspect includes:
a ground base station arranged on ground;
a high-altitude base station arranged within a predetermined altitude range; and
a terminal configured to be capable of connecting to the ground base station and the high-altitude base station, in which
the ground base station and the high-altitude base station are configured to
perform transmission beam sweeping in which directions of transmission beam forming in an orientation of the terminal are sequentially switched, and
the terminal is configured to
perform reception beam sweeping in which directions of reception beam forming in an orientation of the ground base station are sequentially switched only for a time determined in advance,
when the ground base station can be found by reception beam sweeping in the orientation of the ground base station, connect to the ground base station,
when the ground base station cannot be found by reception beam sweeping in the orientation of the ground base station, start reception beam sweeping in which directions of reception beam forming in an orientation of the high-altitude base station are sequentially switched, and
when the high-altitude base station can be found by reception beam sweeping in the orientation of the high-altitude base station, connect to the high-altitude base station.

A terminal according to an aspect includes:
a communication unit configured to be capable of communicating with a ground base station arranged on ground and a high-altitude base station arranged within a predetermined altitude range; and
a processing unit coupled to the communication unit, in which
the processing unit is configured to
perform reception beam sweeping in which directions of reception beam forming in an orientation of the ground base station are sequentially switched only for a time determined in advance,
when the ground base station can be found by reception beam sweeping in the orientation of the ground base station, connect to the ground base station,
when the ground base station cannot be found by reception beam sweeping in the orientation of the ground base station, start reception beam sweeping in which directions of reception beam forming in an orientation of the high-altitude base station are sequentially switched, and
when the high-altitude base station can be found by reception beam sweeping in the orientation of the high-altitude base station, connect to the high-altitude base station.

A control method according to an aspect is
a control method of a terminal, including the steps of:
performing reception beam sweeping in which directions of reception beam forming in an orientation of a ground base station being arranged on ground are sequentially switched only for a time determined in advance;
when the ground base station can be found by reception beam sweeping in the orientation of the ground base station, connecting to the ground base station;
when the ground base station cannot be found by reception beam sweeping in the orientation of the ground base station, starting reception beam sweeping in which directions of reception beam forming in an orientation of a high-altitude base station being arranged in a predetermined altitude range are sequentially switched; and
when the high-altitude base station can be found by reception beam sweeping in the orientation of the high-altitude base station, connecting to the high-altitude base station.

### Advantageous Effects of Invention

According to the aspects described above, an advantageous effect is produced in which a wireless communication system, a terminal, and a control method which enable a terminal to be connected to a ground base station or a high-altitude base station in a short period of time while suppressing power consumption and minimizing communication speed loss can be provided.

### BRIEF DESCRIPTION OF DRAWINGS

FIG. 1 is a diagram showing an overall configuration example of a wireless communication system according to an example embodiment;

FIG. 2 is a block diagram showing a configuration example of a terminal according to the example embodiment;

FIG. 3 is a diagram explaining an operation example of the wireless communication system according to the example embodiment;

FIG. 4 is a diagram explaining an operation example of transmission beam sweeping by a ground base station and reception beam sweeping by a terminal in the wireless communication system according to the example embodiment;

FIG. 5 is a diagram explaining an operation example of transmission beam sweeping by a ground base station and reception beam sweeping by a terminal in the wireless communication system according to the example embodiment;

FIG. 6 is a diagram explaining an operation example of transmission beam sweeping by a high-altitude base station and reception beam sweeping by a terminal in the wireless communication system according to the example embodiment;

FIG. 7 is a diagram explaining an operation example of transmission beam sweeping by a high-altitude base station and reception beam sweeping by a terminal in the wireless communication system according to the example embodiment;

FIG. 8 is a diagram explaining an operation example when a terminal interrupts reception beam sweeping in an orientation of a high-altitude base station with reception beam sweeping in an orientation of a ground base station in the wireless communication system according to the example embodiment;

FIG. 9 is a diagram explaining an operation example when a terminal connects to a high-altitude base station in the wireless communication system according to the example embodiment;

FIG. 10 is a flow diagram explaining an example of a flow of operations until a terminal connects to a ground base station or a high-altitude base station in the wireless communication system according to the example embodiment; and

FIG. 11 is a diagram showing a hardware configuration example of a computer which realizes a part of or all of processing of a terminal according to the example embodiment.

### EXAMPLE EMBODIMENT

Hereinafter, an example embodiment of the present disclosure will be described with reference to the drawings. Note that the following description and the drawings have been omitted and simplified when appropriate for the sake of brevity. In addition, in the respective drawings described below, same elements are denoted by same reference signs and repetitive descriptions have been omitted when necessary.

### Example Embodiment

### <Configuration of Example Embodiment>

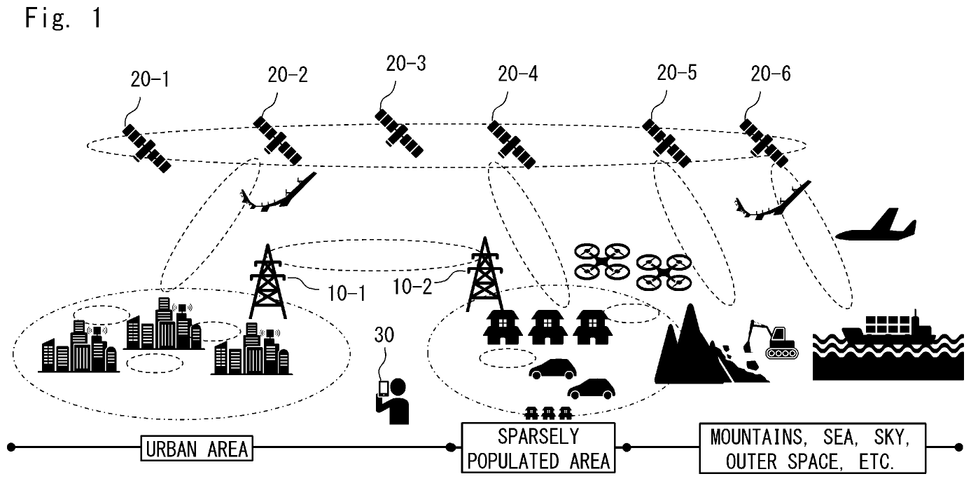

First, an overall configuration example of a wireless communication system according to the present example embodiment will be described with reference to FIG. 1. As shown in FIG. 1, the wireless communication system according to the present example embodiment is equipped with ground base stations 10-1 and 10-2, high-altitude base stations 20-1 to 20-6, and a terminal 30.

Hereinafter, when referring to the ground base stations 10-1 and 10-2 without particularly making a distinction between the ground base stations, the ground base stations may be simply referred to as a “ground base station 10”. In a similar manner, the high-altitude base stations 20-1 to 20-6 may also be simply referred to as a “high-altitude base station 20”.

The ground base station 10 is a base station which is arranged on the ground and of which a position is fixed. Note that the ground base station 10 may be any of a 4G base station or a 5G base station or may be another base station.

The high-altitude base station 20 is a base station which is arranged within a predetermined altitude range and which moves within the altitude range. For example, the high-altitude base station 20 is arranged within a range from the stratosphere to a low orbit or a medium orbit. As an example, when the high-altitude base station 20 is arranged in the stratosphere, the high-altitude base station 20 may be mounted to a HAPS which moves through the stratosphere.

The terminal 30 is a mobile terminal which is capable of connecting to the ground base station 10 and the high-altitude base station 20 and which moves on the ground.

While two ground base stations 10 are provided in FIG. 1, the number of ground base stations 10 may be one or more. In a similar manner, the number of high-altitude base stations 20 may also be one or more. Furthermore, the number of terminals 30 may also be one or more.

In FIG. 1, it is assumed that an area indicated by an alternate long and short dash line is a service area of the ground base station 10 and an area indicated by a dotted line is a service area of the high-altitude base station 20.

In addition, in FIG. 1, it is assumed that a left portion indicates an urban area, a central portion indicates a sparsely populated area, and a right portion indicates mountains, the sea, the sky, outer space, or the like.

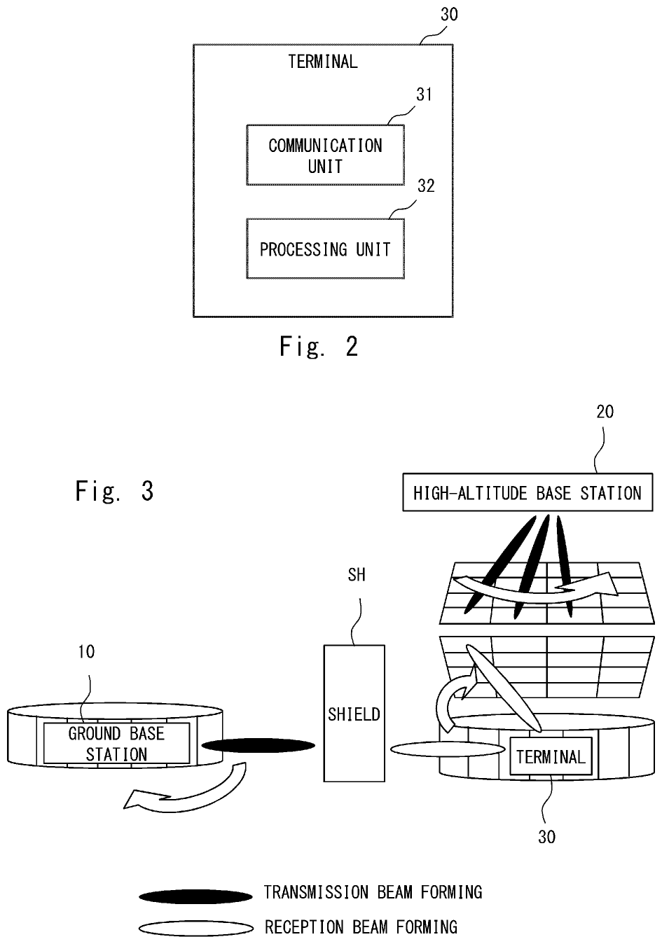

Next, a configuration example of the terminal 30 according to the present example embodiment will be described with reference to FIG. 2. As shown in FIG. 2, the terminal 30 according to the present example embodiment is equipped with a communication unit 31 and a processing unit 32.

The communication unit 31 is capable of performing wireless communication with the ground base station 10 and the high-altitude base station 20. It is assumed that the communication unit 31 is equipped with an antenna (not illustrated) that is usable in common for wireless communication with the ground base station 10 and for wireless communication with the high-altitude base station 20.

The processing unit 32 is coupled to the communication unit 31 and controls the communication unit 31 to perform various kinds of processing. The operations of the terminal 30 described below are assumed to be operations performed by the processing unit 32 by controlling the communication unit 31.

### <Prerequisites for Example Embodiment>

Next, prerequisites for the wireless communication system according to the present example embodiment will be explained.

As described above, an object of the present disclosure is to enable the terminal 30 to be connected to the ground base station 10 or the high-altitude base station 20 in a short period of time while suppressing power consumption and minimizing communication speed loss.

In order to achieve the object described above, a premise of the present example embodiment is that the terminal 30 prioritizes connecting to the ground base station 10 which is closer and which enables high-speed communication and connects to the high-altitude base station 20 when the ground base station 10 is not found.

Other prerequisites are as follows.

Since the high-altitude base station 20 and the terminal 30 move, relative positions between the terminal 30 and each ground base station 10 and between the terminal 30 and each high-altitude base station 20 change over time.

Since the ground base station 10 and the high-altitude base station 20 are connected to a same core network (not illustrated), the ground base station 10 and the high-altitude base station 20 are temporally synchronized. On the other hand, the terminal 30 is not temporally synchronized with each ground base station 10 and each high-altitude base station 20. However, the ground base station 10 and the high-altitude base station 20 are informed of a transmission/reception frequency in an initial stage of connection with the terminal 30 from information such as a SIM (Subscriber Identity Module) of the terminal 30.

The terminal 30 is capable of recognizing an attitude (up and down, horizontal) of the terminal 30 itself using a sensor (not illustrated) mounted to the terminal 30.

High frequency bands of millimeter waves and higher are conceivably utilized in the wireless communication between the terminal 30 and the ground base station and between the terminal 30 and the high-altitude base station 20 in order to further increase communication speed. However, wireless communication utilizing high frequencies of millimeter waves and higher suffers from large propagation loss and, consequently, it is difficult to ensure communication distance. In consideration thereof, for the purpose of extending the communication distance, transmission/reception beam forming is applied to the wireless communication between the terminal 30 and the ground base station 10 and to the wireless communication between the terminal 30 and the high-altitude base station 20 in order to cause energy to concentrate in the communication direction and to improve reception gain.

Due to transmission/reception beam forming of millimeter waves and higher, beams transmitted and received between the terminal 30 and the ground base station 10 and beams transmitted and received between the terminal 30 and the high-altitude base station 20 are sufficiently isolated and, even if a same frequency is used, there is no impact due to interference.

### <Operations According to Example Embodiment>

Next, an operation example of the wireless communication system according to the present example embodiment will be described with reference to FIG. 3.

As described above, the terminal 30 prioritizes connecting to a ground base station 10 which is close and which is capable of high-speed communication. Therefore, first, both the ground base station 10 and the terminal 30 must find each other.

Therefore, as shown in FIG. 3, first, the ground base station 10 performs transmission beam forming in an orientation of the terminal 30 and the terminal performs reception beam forming in an orientation of the ground base station 10.

However, unless a direction of the transmission beam forming by the ground base station 10 and a direction of the reception beam forming by the terminal 30 coincide with each other at a same time, both the ground base station and the terminal 30 cannot find each other.

In consideration thereof, the ground base station 10 performs transmission beam sweeping in which the ground base station 10 sequentially switches directions of transmission beam forming in the orientation of the terminal 30, and the terminal 30 performs reception beam sweeping in which the terminal 30 sequentially switches directions of reception beam forming in the orientation of the ground base station 10.

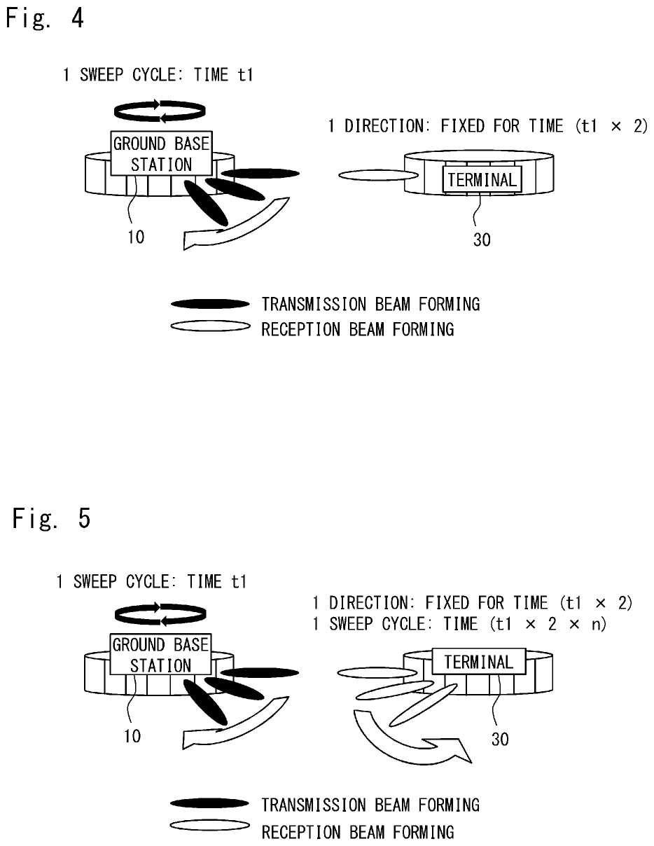

Operation examples of the transmission beam sweeping by the ground base station 10 and the reception beam sweeping by the terminal 30 will now be explained with reference to FIG. 4 and FIG. 5.

As shown in FIG. 4, the ground base station 10 continuously performs transmission beam sweeping in a horizontal direction.

In this case, it is assumed that a time of one sweep cycle by the ground base station 10 is a time t1. In this case, the terminal 30 performing reception beam sweeping fixes a direction of the reception beam to one horizontal direction during a time corresponding to two sweep cycles (t1×2). In addition, the terminal 30 sequentially changes the direction of the reception beam in the horizontal direction at every time (t1×2). The time during which the direction of the reception beam is fixed is set to two sweep cycles in order to ensure that the ground base station 10 and the terminal 30 do not miss each other due to a timing lag when the ground base station 10 and the terminal 30 are not temporally synchronized. However, two sweep cycles are merely an example and the time during which the direction of the reception beam is fixed is not limited thereto. For example, the terminal 30 may ensure that the ground base station 10 and the terminal 30 do not miss each other by sequentially changing the directions of the reception beam at every time longer than t1.

In addition, in this case, as shown in FIG. 5, it is assumed that there are n-number (where n is an integer equal to or larger than 2) of directions of the reception beam in the terminal 30 in the horizontal direction. In this case, a time of one sweep cycle by the terminal 30 is a time (t1×2×n). This means that, as long as the terminal 30 is at a position that can be reached by a reception beam (in other words, a radio wave) from the ground base station 10 (in other words, within a cell of the ground base station 10), the terminal 30 can receive the reception beam within the time (t1×2×n) at the longest.

Note that in the ground base station 10 and the terminal 30, an order of sweeps may be selected from a method of making one revolution in order from an edge, a method of switching at random, and a method of gradually moving away from a central direction which has been proven to be successful in the past.

Returning to FIG. 3, the ground base station 10 continuously performs transmission beam sweeping in the orientation of the terminal 30. On the other hand, the terminal 30 performs reception beam sweeping in the orientation of the ground base station 10 only for a time determined in advance. In the example shown in FIG. 4 and FIG. 5, the time determined in advance may be set to the time (t1×2×n).

When the terminal 30 receives the reception beam from the ground base station 10 due to reception beam sweeping in the orientation of the ground base station 10 or, in other words, when the terminal 30 is able to find the ground base station 10, the terminal 30 connects to the ground base station 10. An operation when the terminal 30 connects to the ground base station 10 will be described later.

On the other hand, when the terminal 30 cannot receive the reception beam from the ground base station 10 even after performing reception beam sweeping in the orientation of the ground base station 10 for the time determined in advance or, in other words, when the terminal 30 is unable to find the ground base station 10, the terminal 30 attempts to connect to the high-altitude base station 20. The example shown in FIG. 3 represents an example in which the terminal 30 is unable to find the ground base station 10 due to the presence of a shield SH between the ground base station 10 and the terminal 30.

In this case, in order for the terminal 30 to connect to the high-altitude base station 20, both the high-altitude base station 20 and the terminal 30 must find each other.

In this case, the high-altitude base station 20 is continuously performing transmission beam sweeping in which the high-altitude base station 20 sequentially switches directions of transmission beam forming in the orientation of the terminal 30. On the other hand, the terminal 30 still unable to find the ground base station 10 starts reception beam sweeping in which the terminal 30 sequentially switches directions of reception beam forming in the orientation of the high-altitude base station 20 at a timing where the time determined in advance has elapsed.

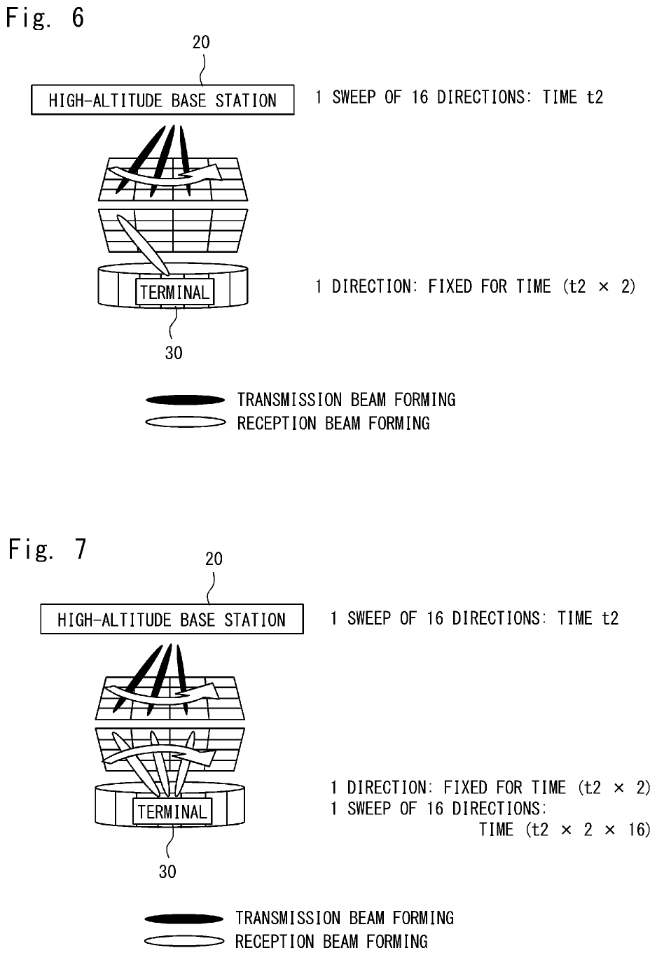

Operation examples of the transmission beam sweeping by the high-altitude base station 20 and the reception beam sweeping by the terminal 30 will now be explained with reference to FIG. 6 and FIG. 7. In this case, it is assumed that both directions of the transmission beam in the high-altitude base station 20 and directions of the reception beam in the terminal 30 are four directions in the horizontal direction and four directions in a vertical direction for a total of 16 (=4×4) directions.

As shown in FIG. 6, the high-altitude base station 20 continuously performs transmission beam sweeping in the total of 16 directions in the horizontal direction and the vertical direction.

In this case, it is assumed that a time of a sweep by the high-altitude base station 20 in the 16 directions is a time t2. In this case, the terminal 30 performing reception beam sweeping fixes a direction of the reception beam to one of the 16 directions during a time corresponding to two sweeps (t2×2) in the 16 directions. In addition, the terminal 30 sequentially changes the direction of the reception beam at every time (t2×2). Note that the sweep time in the 16 directions is set to two sweeps in order to ensure that the high-altitude base station 20 and the terminal 30 do not miss each other due to a timing lag when the high-altitude base station 20 and the terminal 30 are not temporally synchronized. However, two sweeps is merely an example and the sweep time in the 16 directions is not limited thereto. For example, the terminal 30 may ensure that the high-altitude base station 20 and the terminal 30 do not miss each other by sequentially changing the directions of the reception beam at every time longer than t2.

In addition, in this case, as shown in FIG. 6 and FIG. 7, the number of directions of the reception beam in the terminal 30 is 16 directions. In this case, a time of a sweep by the terminal 30 in the 16 directions is a time (t2×2×16). This means that, as long as the terminal 30 is at a position that can be reached by a reception beam (in other words, a radio wave) from the high-altitude base station 20 (in other words, within a cell of the high-altitude base station 20), the terminal 30 can receive the reception beam within the time (t2×2×16) at the longest.

Note that in the high-altitude base station 20 and the terminal 30, an order of sweeps may be selected from a method of switching in order from an edge, a method of switching at random, and a method of gradually moving away from a central direction which has been proven to be successful in the past.

Returning to FIG. 3, the high-altitude base station 20 continuously performs transmission beam sweeping in the orientation of the terminal 30.

When the terminal 30 receives the reception beam from the high-altitude base station 20 due to reception beam sweeping in the orientation of the high-altitude base station 20 or, in other words, when the terminal 30 is able to find the high-altitude base station 20, the terminal 30 connects to the high-altitude base station 20. An operation when the terminal 30 connects to the high-altitude base station 20 will be described later.

In this case, the terminal 30 has started reception beam sweeping in the orientation of the high-altitude base station 20 when the terminal 30 has been unable to find the ground base station 10. However, since the terminal 30 moves, there is a possibility that the terminal 30 may find the ground base station at a destination of the movement. For example, in the example shown in FIG. 3, there is a possibility that the terminal 30 may find the ground base station 10 if the terminal 30 has moved to a position where the shield SH can be avoided.

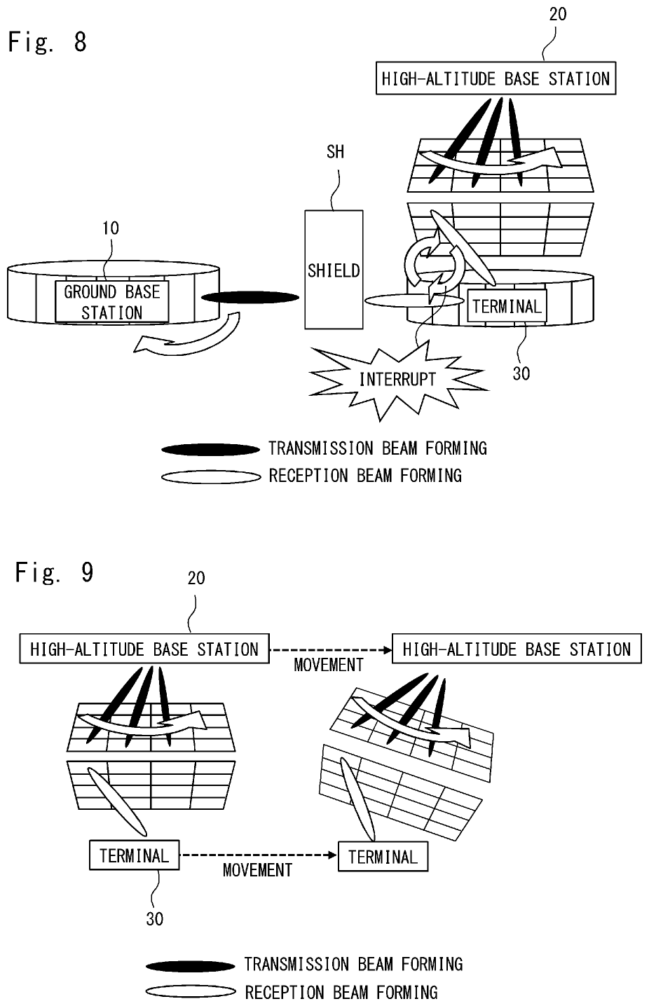

Therefore, as shown in FIG. 8, in order to be able to preferentially connect to the ground base station 10 when the terminal 30 is able to find the ground base station 10, the terminal 30 interrupts the reception beam sweeping in the orientation of the high-altitude base station 20 with the reception beam sweeping in the orientation of the ground base station 10.

In addition, in this case, the terminal 30 sets a ratio of the reception beam sweeping in the orientation of the ground base station 10 to be higher than a ratio of the reception beam sweeping in the orientation of the high-altitude base station 20. Accordingly, a priority of connection to the ground base station 10 is maintained higher than a priority of connection to the high-altitude base station 20.

In this case, examples of a system for interrupting the reception beam sweeping in the orientation of the high-altitude base station 20 with the reception beam sweeping in the orientation of the ground base station 10 include the following. If the reception beam sweeping in the orientation of the ground base station 10 is denoted by S1 and the reception beam sweeping in the orientation of the high-altitude base station 20 is denoted by S2, then a system of interrupting S1 with S2 at regular intervals so that a ratio of S1 is larger is conceivable as exemplified by S1, S1, S2, S1, S1, S2, . . . . In addition, in this system, a sweep of one direction's worth of the reception beam (a sweep corresponding to time (t1×2) in the example shown in FIG. 4 and FIG. 5) may be performed in the first S1, and a sweep of one direction's worth of the reception beam (a sweep corresponding to time (t2×2) in the example shown in FIG. 6 and FIG. 7) may be performed in the first S2. However, how far reception beam sweeping is to be respectively advanced in the first S1 and the first S2 may be arbitrarily determined.

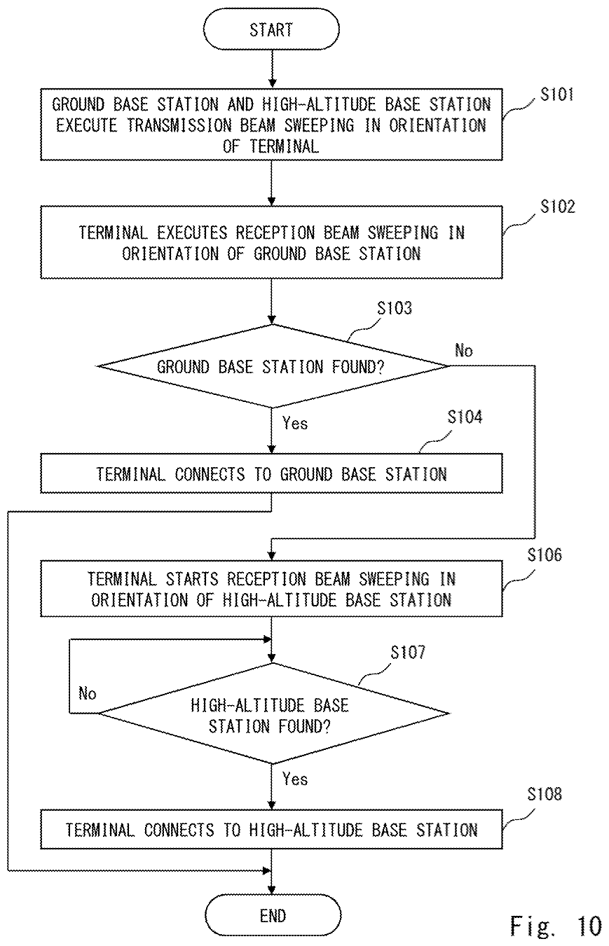

Next, an operation example when the terminal 30 connects to the high-altitude base station 20 will be described with reference to FIG. 9.

The terminal 30 finds the high-altitude base station 20 by receiving a beam from the high-altitude base station 20 due to reception beam sweeping in the orientation of the high-altitude base station 20. The beam from the high-altitude base station 20 includes information on a position of the high-altitude base station 20, information on a transmission time of the beam, an ID (Identification) of the high-altitude base station 20, information on a movement direction, a speed, and an acceleration of the high-altitude base station 20, and information on a transmission timing of the terminal 30 to be given next. Therefore, the terminal discerns a beam direction of a beam to be transmitted to the high-altitude base station 20 from a direction in which a beam is received.

However, since the high-altitude base station 20 and the terminal 30 move as shown in FIG. 9, relative positions between the terminal 30 and the high-altitude base station 20 change over time.

Therefore, when the given transmission timing arrives, the terminal 30 corrects the beam direction of the beam to be transmitted to the high-altitude base station 20 based on the movement direction, the speed, and the acceleration of the high-altitude base station 20 and the movement direction, the speed, and the acceleration of the terminal 30, and transmits the beam in the corrected beam direction. Accordingly, transmission and reception of the beam are established between the high-altitude base station 20 and the terminal 30 and the high-altitude base station 20 and the terminal 30 are connected to each other.

The terminal 30 calculates a distance between the high-altitude base station 20 and the terminal 30 by calculating a propagation delay due to the transmission and reception of the beam. The terminal 30 estimates a position of the terminal 30 by performing the distance calculation with respect to three or more base stations (while a distance calculation of the high-altitude base station may be performed, a distance calculation of the ground base station 10 of which a position is fixed is more suitable). The beam transmitted from the terminal 30 includes an ID of the terminal 30, information on the position of the terminal 30, and information on the movement direction, the speed, and the acceleration of the terminal 30.

The high-altitude base station 20 also corrects a beam direction of a beam to be transmitted to the terminal 30 based on information included in the beam from the terminal 30.

Subsequently, the high-altitude base station 20 and the terminal 30 continue to correct beam directions in parallel with transmitting and receiving beams.

Once the connection between the high-altitude base station 20 and the terminal 30 drops, the high-altitude base station 20 and the terminal 30 return to initial operations and perform reconnection.

While operations when the terminal 30 connects to the high-altitude base station 20 have been described above, operations when the terminal 30 connects to the ground base station 10 are approximately similar. However, since the position of the ground base station 10 is fixed, there is no need to include information on a movement direction, a speed, and an acceleration of the ground base station 10 in a beam to be transmitted to the terminal 30.

Next, an example of a flow of operations until the terminal 30 connects to the ground base station 10 or the high-altitude base station 20 will be described with reference to FIG. 10.

As shown in FIG. 10, the ground base station 10 and the high-altitude base station 20 perform transmission beam sweeping in the orientation of the terminal (step S101).

In addition, the terminal 30 first performs reception beam sweeping in the orientation of the ground base station 10 only for a time determined in advance (step S102).

When the terminal 30 is able to find the ground base station 10 due to reception beam sweeping in the orientation of the ground base station 10 (Yes in step S103), the terminal 30 connects to the ground base station 10 (step S104). Subsequently, the processing is ended.

On the other hand, when the terminal 30 is unable to find the ground base station 10 even after performing reception beam sweeping in the orientation of the ground base station 10 for the time determined in advance (No in step S103), the terminal 30 next starts reception beam sweeping in the orientation of the high-altitude base station 20 (step S106).

When the terminal 30 is able to find the high-altitude base station 20 due to reception beam sweeping in the orientation of the high-altitude base station 20 (Yes in step S107), the terminal 30 connects to the high-altitude base station 20 (step S108). Subsequently, the processing is ended.

On the other hand, when the terminal 30 is unable to find the high-altitude base station 20, the terminal 30 returns to step S107 and continues to perform reception beam sweeping in the orientation of the high-altitude base station 20. However, the terminal 30 is not limited to this operation.

As described with reference to FIG. 8, the terminal 30 may interrupt the reception beam sweeping in the orientation of the high-altitude base station 20 in step S107 with the reception beam sweeping in the orientation of the ground base station 10. In addition, when the terminal 30 is able to find the ground base station 10 due to the interrupted reception beam sweeping in the orientation of the ground base station 10, the terminal 30 may connect to the ground base station 10.

### <Advantageous Effect of Example Embodiment>

As described above, according to the present example embodiment, the ground base station 10 and the high-altitude base station 20 perform transmission beam sweeping in the orientation of the terminal 30. The terminal 30 first performs reception beam sweeping in the orientation of the ground base station 10 and, when the terminal 30 is able to find the ground base station 10, the terminal 30 connects to the ground base station 10. On the other hand, when the terminal is unable to find the ground base station 10, the terminal 30 next starts reception beam sweeping in the orientation of the high-altitude base station 20 and, when the terminal 30 is able to find the high-altitude base station 20, the terminal 30 connects to the high-altitude base station 20.

Therefore, the terminal 30 can preferentially connect to the ground base station 10 which is close and which is capable of high-speed communication. Due to communication with the nearby ground base station 10, the terminal 30 can suppress power consumption and maintain a high communication speed. In addition, when the terminal 30 is unable to find the ground base station 10, the terminal 30 can find the high-altitude base station 20 due to reception beam sweeping in the orientation of the high-altitude base station 20 and connect to the high-altitude base station 20. Accordingly, the terminal 30 can connect to the ground base station 10 or the high-altitude base station 20 in a short period of time while suppressing power consumption and minimizing communication speed loss.

### <Hardware Configuration of Terminal According to Example Embodiment>

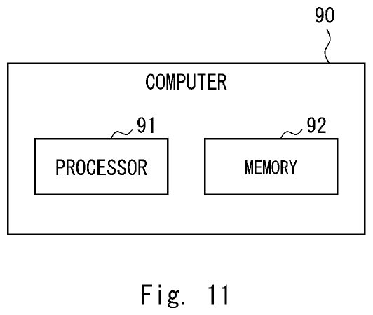

Next, a hardware configuration example of a computer 90 which realizes a part of or all of processing by the terminal 30 according to the example embodiment described above will be explained with reference to FIG. 11. The computer 90 shown in FIG. 11 is equipped with a processor 91 and a memory 92.

For example, the processor 91 may be a microprocessor, an MPU (Micro Processing Unit), or a CPU (Central Processing Unit). The processor 91 may include a plurality of processors.

The memory 92 is constituted of a combination of a volatile memory and a non-volatile memory. The memory 92 may include a storage arranged at a distance from the processor 91. In this case, the processor 91 may access the memory 92 via an I (Input)/O (Output) interface (not illustrated).

In addition, the communication unit 31 and the processing unit 32 in the terminal 30 according to the example embodiment described above may be realized by the processor 91 by reading and executing a program stored in the memory 92.

In addition, the program described above can be stored and supplied to a computer using various types of non-transitory computer readable media. Non-transitory computer readable media include any type of tangible storage media. Examples of non-transitory computer readable media include magnetic storage media (such as a floppy disk, a magnetic tape, and a hard disk drive), optical magnetic storage media (such as a magneto-optical disk), a CD-ROM (Compact Disc-ROM), a CD-R (CD-Recordable), a CD-R/W (CD-Rewritable), and semiconductor memories (such as a mask ROM, a PROM (Programmable ROM), an EPROM (Erasable PROM), a flash ROM, and a RAM. In addition, the program can be supplied to a computer using various types of transitory computer readable media. Examples of transitory computer readable media include an electric signal, an optical signal, and electromagnetic waves. Transitory computer readable media can supply the program to a computer via a wired communication line (such as an electric wire or an optical fiber) or a wireless communication line.

While the present disclosure has been described above with reference to an example embodiment, the present invention is not limited to the example embodiment described above. Various modifications to the configurations and details of the present disclosure will occur to and can be made by those skilled in the art within the scope of the present disclosure.

In addition, a part of or all of the example embodiment described above may be described as, but not limited to, the following supplementary notes.

### (Supplementary Note 1)

A wireless communication system, comprising:
a ground base station arranged on ground;
a high-altitude base station arranged within a predetermined altitude range; and
a terminal configured to be capable of connecting to the ground base station and the high-altitude base station, in which
the ground base station and the high-altitude base station are configured to
perform transmission beam sweeping in which directions of transmission beam forming in an orientation of the terminal are sequentially switched, and
the terminal is configured to
perform reception beam sweeping in which directions of reception beam forming in an orientation of the ground base station are sequentially switched only for a time determined in advance,
when the ground base station can be found by reception beam sweeping in the orientation of the ground base station, connect to the ground base station,
when the ground base station cannot be found by reception beam sweeping in the orientation of the ground base station, start reception beam sweeping in which directions of reception beam forming in an orientation of the high-altitude base station are sequentially switched, and
when the high-altitude base station can be found by reception beam sweeping in the orientation of the high-altitude base station, connect to the high-altitude base station.

### (Supplementary Note 2)

The wireless communication system according to supplementary note 1, in which
the terminal is configured to
interrupt the reception beam sweeping in the orientation of the high-altitude base station with the reception beam sweeping in the orientation of the ground base station.

### (Supplementary Note 3)

The wireless communication system according to supplementary note 2, in which
the terminal is configured to
set a ratio of the reception beam sweeping in the orientation of the ground base station to be higher than a ratio of the reception beam sweeping in the orientation of the high-altitude base station when interrupting the reception beam sweeping in the orientation of the high-altitude base station with the reception beam sweeping in the orientation of the ground base station.

### (Supplementary Note 4)

The wireless communication system according to any one of supplementary notes 1 to 3, in which
the ground base station and the high-altitude base station are configured to
when performing the transmission beam sweeping in the orientation of the terminal, sequentially switch directions of the transmission beam forming in the orientation of the terminal to a plurality of directions determined in advance, and
the terminal is configured to
when performing the reception beam sweeping in the orientation of the ground base station or the high-altitude base station, sequentially switch directions of the reception beam forming in the orientation of the ground base station or the high-altitude base station to a plurality of directions determined in advance.

### (Supplementary Note 5)

The wireless communication system according to supplementary note 4, in which
the terminal is configured to
when performing the reception beam sweeping in the orientation of the ground base station or the high-altitude base station, after fixing a direction of the reception beam forming in the orientation of the ground base station or the high-altitude base station for a time determined in advance, switch to another direction.

### (Supplementary Note 6)

The wireless communication system according to any one of supplementary notes 1 to 5, in which
the terminal is configured to
when connecting to the ground base station or the high-altitude base station, continue to correct a beam direction of a beam to be transmitted to the ground base station or the high-altitude base station based on information included in a beam received from the ground base station or the high-altitude base station in parallel with transmitting and receiving a beam to and from the ground base station or the high-altitude base station, and
the ground base station and the high-altitude base station are configured to
when connecting to the terminal, continue to correct a beam direction of a beam to be transmitted to the terminal based on information included in a beam received from the terminal in parallel with transmitting and receiving a beam to and from the terminal.

### (Supplementary Note 7)

A terminal, comprising:
a communication unit configured to be capable of communicating with a ground base station arranged on ground and a high-altitude base station arranged within a predetermined altitude range; and
a processing unit coupled to the communication unit, in which
the processing unit is configured to
perform reception beam sweeping in which directions of reception beam forming in an orientation of the ground base station are sequentially switched only for a time determined in advance,
when the ground base station can be found by reception beam sweeping in the orientation of the ground base station, connect to the ground base station,
when the ground base station cannot be found by reception beam sweeping in the orientation of the ground base station, start reception beam sweeping in which directions of reception beam forming in an orientation of the high-altitude base station are sequentially switched, and
when the high-altitude base station can be found by reception beam sweeping in the orientation of the high-altitude base station, connect to the high-altitude base station.

### (Supplementary Note 8)

The terminal according to supplementary note 7, in which
the processing unit is configured to
interrupt the reception beam sweeping in the orientation of the high-altitude base station with the reception beam sweeping in the orientation of the ground base station.

### (Supplementary Note 9)

The terminal according to supplementary note 8, in which the processing unit is configured to
set a ratio of the reception beam sweeping in the orientation of the ground base station to be higher than a ratio of the reception beam sweeping in the orientation of the high-altitude base station when interrupting the reception beam sweeping in the orientation of the high-altitude base station with the reception beam sweeping in the orientation of the ground base station.

### (Supplementary Note 10)

The terminal according to any one of supplementary notes 7 to 9, in which the processing unit is configured to
when performing the reception beam sweeping in the orientation of the ground base station or the high-altitude base station, sequentially switch directions of the reception beam forming in the orientation of the ground base station or the high-altitude base station to a plurality of directions determined in advance.

### (Supplementary Note 11)

The terminal according to supplementary note 10, in which the processing unit is configured to
when performing the reception beam sweeping in the orientation of the ground base station or the high-altitude base station, after fixing a direction of the reception beam forming in the orientation of the ground base station or the high-altitude base station for a time determined in advance, switch to another direction.

### (Supplementary Note 12)

The terminal according to any one of supplementary notes 7 to 11, in which
the processing unit is configured to
when connecting to the ground base station or the high-altitude base station, continue to correct a beam direction of a beam to be transmitted to the ground base station or the high-altitude base station based on information included in a beam received from the ground base station or the high-altitude base station in parallel with transmitting and receiving a beam to and from the ground base station or the high-altitude base station.

### (Supplementary Note 13)

A control method of a terminal, comprising the steps of:
performing reception beam sweeping in which directions of reception beam forming in an orientation of a ground base station being arranged on ground are sequentially switched only for a time determined in advance;
when the ground base station can be found by reception beam sweeping in the orientation of the ground base station, connecting to the ground base station;
when the ground base station cannot be found by reception beam sweeping in the orientation of the ground base station, starting reception beam sweeping in which directions of reception beam forming in an orientation of a high-altitude base station being arranged in a predetermined altitude range are sequentially switched; and
when the high-altitude base station can be found by reception beam sweeping in the orientation of the high-altitude base station, connecting to the high-altitude base station.

The present application claims priority on the basis of Japanese Patent Application No. 2021-051506 filed on Mar. 25, 2021, the entire contents of which are incorporated herein by reference.

### REFERENCE SIGNS LIST

10-1, 10-2 GROUND BASE STATION
20-1 TO 20-6 HIGH-ALTITUDE BASE STATION
30 TERMINAL
31 COMMUNICATION UNIT
32 PROCESSING UNIT
90 COMPUTER
91 PROCESSOR
92 MEMORY

What is claimed is:

1. A wireless communication system, comprising:
a ground base station arranged on ground;
a high-altitude base station arranged within a predetermined altitude range; and
a terminal configured to be capable of connecting to the ground base station and the high-altitude base station, wherein
the ground base station and the high-altitude base station are configured to
perform transmission beam sweeping in which directions of transmission beam forming in an orientation of the terminal are sequentially switched, and
the terminal is configured to
perform reception beam sweeping in which directions of reception beam forming in an orientation of the ground base station are sequentially switched only for a time determined in advance,
when the ground base station can be found by reception beam sweeping in the orientation of the ground base station, connect to the ground base station,
when the ground base station cannot be found by reception beam sweeping in the orientation of the ground base station, start reception beam sweeping in which directions of reception beam forming in an orientation of the high-altitude base station are sequentially switched, and
when the high-altitude base station can be found by reception beam sweeping in the orientation of the high-altitude base station, connect to the high-altitude base station.

2. The wireless communication system according to claim 1, wherein
the terminal is configured to
interrupt the reception beam sweeping in the orientation of the high-altitude base station with the reception beam sweeping in the orientation of the ground base station.

3. The wireless communication system according to claim 2, wherein
the terminal is configured to
set a ratio of the reception beam sweeping in the orientation of the ground base station to be higher than a ratio of the reception beam sweeping in the orientation of the high-altitude base station when interrupting the reception beam sweeping in the orientation of the high-altitude base station with the reception beam sweeping in the orientation of the ground base station.

4. The wireless communication system according to claim 1, wherein
the ground base station and the high-altitude base station are configured to
when performing the transmission beam sweeping in the orientation of the terminal, sequentially switch directions of the transmission beam forming in the orientation of the terminal to a plurality of directions determined in advance, and
the terminal is configured to
when performing the reception beam sweeping in the orientation of the ground base station or the high-altitude base station, sequentially switch directions of the reception beam forming in the orientation of the ground base station or the high-altitude base station to a plurality of directions determined in advance.

5. The wireless communication system according to claim 4, wherein
the terminal is configured to
when performing the reception beam sweeping in the orientation of the ground base station or the high-altitude base station, after fixing a direction of the reception beam forming in the orientation of the ground base station or the high-altitude base station for a time determined in advance, switch to another direction.

6. The wireless communication system according to claim 1, wherein
the terminal is configured to
when connecting to the ground base station or the high-altitude base station, continue to correct a beam direction of a beam to be transmitted to the ground base station or the high-altitude base station based on information included in a beam received from the ground base station or the high-altitude base station in parallel with transmitting and receiving a beam to and from the ground base station or the high-altitude base station, and
the ground base station and the high-altitude base station are configured to
when connecting to the terminal, continue to correct a beam direction of a beam to be transmitted to the terminal based on information included in a beam received from the terminal in parallel with transmitting and receiving a beam to and from the terminal.

7. A terminal, comprising:
a transceiver configured to be capable of communicating with a ground base station arranged on ground and a high-altitude base station arranged within a predetermined altitude range, and
at least one memory storing instructions; and
at least one processor coupled to the transceiver and the at least one memory, wherein
the at least one processor is configured to execute the instructions to
perform reception beam sweeping in which directions of reception beam forming in an orientation of the ground base station are sequentially switched only for a time determined in advance,
when the ground base station can be found by reception beam sweeping in the orientation of the ground base station, connect to the ground base station,
when the ground base station cannot be found by reception beam sweeping in the orientation of the ground base station, start reception beam sweeping in which directions of reception beam forming in an orientation of the high-altitude base station are sequentially switched, and
when the high-altitude base station can be found by reception beam sweeping in the orientation of the high-altitude base station, connect to the high-altitude base station.

8. The terminal according to claim 7, wherein
the at least one processor is configured to execute the instructions to
interrupt the reception beam sweeping in the orientation of the high-altitude base station with the reception beam sweeping in the orientation of the ground base station.

9. The terminal according to claim 8, wherein
the at least one processor is configured to execute the instructions to
set a ratio of the reception beam sweeping in the orientation of the ground base station to be higher than a ratio of the reception beam sweeping in the orientation of the high-altitude base station when interrupting the reception beam sweeping in the orientation of the high-altitude base station with the reception beam sweeping in the orientation of the ground base station.

10. The terminal according to claim 7, wherein
the at least one processor is configured to execute the instructions to
when performing the reception beam sweeping in the orientation of the ground base station or the high-altitude base station, sequentially switch directions of the reception beam forming in the orientation of the ground base station or the high-altitude base station to a plurality of directions determined in advance.

11. The terminal according to claim 10, wherein
the at least one processor is configured to execute the instructions to
when performing the reception beam sweeping in the orientation of the ground base station or the high-altitude base station, after fixing a direction of the reception beam forming in the orientation of the ground base station or the high-altitude base station for a time determined in advance, switch to another direction.

12. The terminal according to claim 7, wherein
the at least one processor is configured to execute the instructions to
when connecting to the ground base station or the high-altitude base station, continue to correct a beam direction of a beam to be transmitted to the ground base station or the high-altitude base station based on information included in a beam received from the ground base station or the high-altitude base station in parallel with transmitting and receiving a beam to and from the ground base station or the high-altitude base station.

13. A control method of a terminal, comprising the steps of:
performing reception beam sweeping in which directions of reception beam forming in an orientation of a ground base station being arranged on ground are sequentially switched only for a time determined in advance;
when the ground base station can be found by reception beam sweeping in the orientation of the ground base station, connecting to the ground base station;
when the ground base station cannot be found by reception beam sweeping in the orientation of the ground base station, starting reception beam sweeping in which directions of reception beam forming in an orientation of a high-altitude base station being arranged in a predetermined altitude range are sequentially switched; and
when the high-altitude base station can be found by reception beam sweeping in the orientation of the high-altitude base station, connecting to the high-altitude base station.
